(19) United States
(12) Patent Application Publication
(10) Pub. No.: US 2023/0099936 A1
(43) Pub. Date: Mar. 30, 2023

(54) PORTABLE OFFICE

(71) Applicant: Worky Life LLC, (US)

(72) Inventors: Todd FOLKMAN, Miami, FL (US); Corey LIEBLEIN, Sands Point, NY (US); Richard SMULLEN, Sands Point, NY (US)

(21) Appl. No.: 18/076,292

(22) Filed: Dec. 6, 2022

Related U.S. Application Data
(63) Continuation-in-part of application No. PCT/US2021/037163, filed on Jun. 14, 2021.
Application No. PCT/US2021/037163 is a continuation of application No. 17/000,361, filed on Aug. 23, 2020, now Pat. No. 11,154,123.
(60) Provisional application No. 63/039,451, filed on Jun. 15, 2020.
(60) Provisional application No. 63/039,451, filed on Jun. 15, 2020.

(51) Int. Cl. A45C 9/00; A45C 15/06; A45C 3/02; A45C 13/02; E05B 65/52

(52) U.S. Cl. CPC A45C 9/00; A45C 15/06; A45C 3/02; A45C 13/02; E05B 65/52; A45C 2013/025; A45C 2200/20

(57) ABSTRACT

Various embodiments of a portable office comprise a base and a lid that attach to each other, a support for a portable computer, and one or more component or accessory holders. In one embodiment, there is provided a detachable illumination device and a detachable writing board.

### CROSS-REFERENCE TO RELATED APPLICATIONS

This application is a continuation-in-part application of international application PCT/US2021/037163, filed on Jun. 14, 2021, and designated the U.S. International application PCT/US2021/037163 claims priority to and the benefit of the provisional patent application, application No. 63/039,451, filed in the United States Patent and Trademark Office on Jun. 15, 2020, and of the non-provisional patent application, application Ser. No. 17/000,361, filed in the United States Patent and Trademark Office on Aug. 23, 2020. The entire contents of the above referenced patent applications are incorporated herein by reference.

### FIELD

The apparatus disclosed herein relates to a portable office apparatus, hereafter in one embodiment described as a portable office-in-a-box. The portable office-in-a-box allows a user to readily transport and set up an office and workstation at any location, for example, at a location remote from the user's brick and mortar office or residence, and to allow the user to work in an office setting at the transported location.

In an embodiment, the office-in-a-box disclosed herein is a workstation that allows a user to conveniently and safely transports office equipment and work materials to any location, for example, at a location remote from the user's brick and mortar office, for example, to a conference, where the user can perform office functions and showcase presentation materials posted or displayed in the office-in-a-box to third parties at the conference.

### BACKGROUND

Professional persons like managers, engineers, sales personnel, freelancers, etc. hereafter a user, who are on the move need an office-in-a-box that can be easily transported to a location, remote from the user's normal brick and mortar office, and thereafter allow the transported portable office-in-a box to be readily installed and set up at the remote location.

There is a long felt but unmet need for a portable office that a user can readily transport and set up an office and workstation at any location, for example, at a location remote from the user's brick and mortar office or residence, and to allow the user to work in an office setting at any location. There is also a long felt but unmet need for a portable office-in-a-box to accommodate and to make readily available to a user multiple office desk devices at the office-in-a-box's transported location. There is also a long felt but unmet need for a portable office-in-a-box that a user can use as a presentation office to showcase and display user material to a potential client, an audience, etc., at any location, for example, at a conference, at a client's or potential customer's office, etc. Furthermore, there is a long felt but unmet need for a portable office-in-a-box that is compact in design, easy to store, lightweight, durable, transportable and that allows a user to easily assemble and transport the portable office-in-a box to any location, and thereafter to readily assemble and set-up the portable office-in-a box at the transported location.

### BRIEF DESCRIPTION OF THE DRAWINGS

FIG. 1 exemplarily illustrates a front left-side perspective view of one embodiment of a portable office-in-a-box with one or more office items.

FIG. 2 exemplarily illustrates a front right-side perspective view of the portable office-in-a-box in an open configuration.

FIG. 3 exemplarily illustrates another front left-side perspective of the portable office-in-a-box in the open configuration.

FIG. 4A exemplarily illustrates a front left-side top perspective view of the portable office-in-a-box in a closed configuration.

FIG. 4B exemplarily illustrates a front right-side top perspective view of the portable office-in-a-box in the closed configuration.

FIG. 4C exemplarily illustrates a rear perspective view of the portable office-in-a-box in a closed configuration.

FIG. 4D exemplarily illustrates a plug-in adapter of the portable office-in-a-box in a pulled-out configuration from a rear portion of the portable office-in-a-box.

FIG. 5A exemplarily illustrates a rear perspective view of the portable office-in-a-box in the open configuration.

FIG. 5B exemplarily illustrates a bottom perspective view of the portable office-in-a-box in an open configuration.

FIG. 5C exemplarily illustrates a front orthogonal view of the portable office-in-a-box in the open configuration.

FIG. 5D exemplarily illustrates a rear orthogonal view of the portable office-in-a-box in the open configuration.

FIG. 5E exemplarily illustrates a left side orthogonal view of the portable office-in-a-box in the open configuration.

FIG. 5F exemplarily illustrates a right-side orthogonal view of the portable office-in-a-box in the open configuration.

FIG. 5G exemplarily illustrates a top plan view of the portable office-in-a-box in the open configuration.

FIGS. 6A-6C exemplarily illustrate a hinge disposed between the lid and the base for hingedly connecting the lid and the base.

FIG. 7A exemplarily illustrates a front perspective view of one embodiment of a portable office in an open configuration.

FIG. 7B exemplarily illustrates another front perspective view of the portable office in an open configuration and in use.

FIG. 7C exemplarily illustrates a front perspective view of the portable office in a closed configuration.

### DETAILED DESCRIPTION

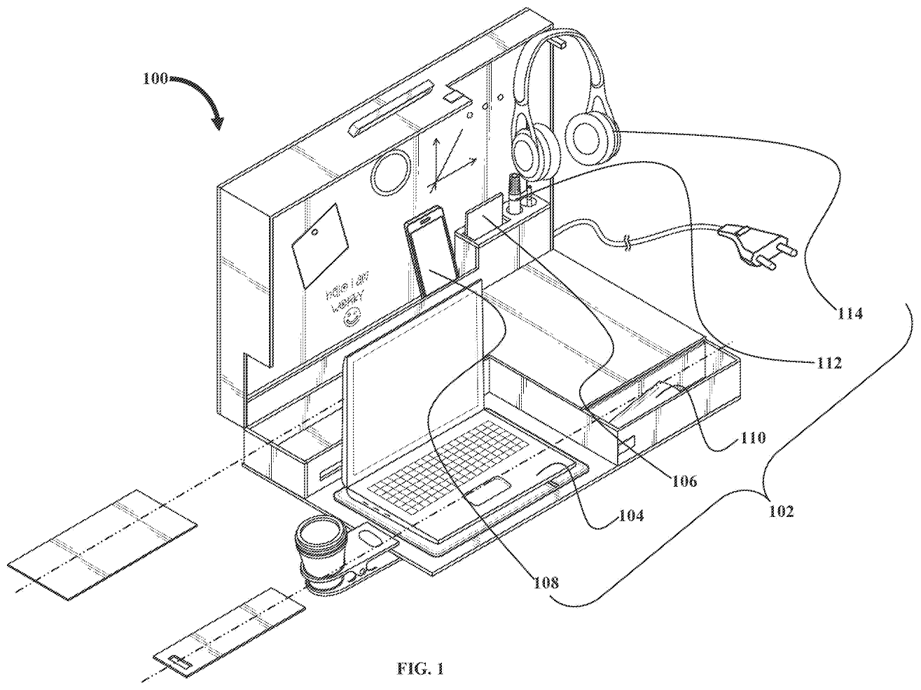

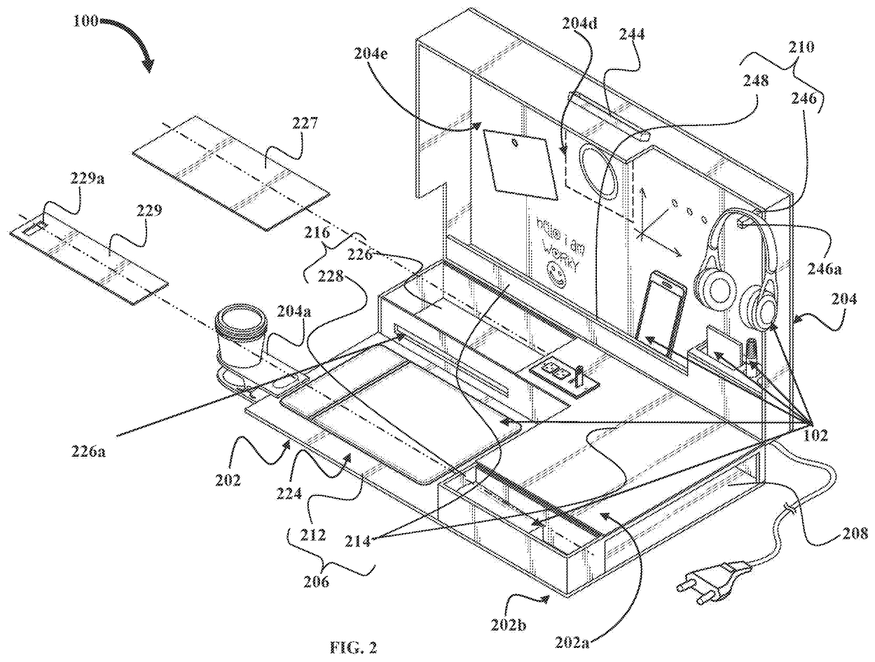

One embodiment of an apparatus disclosed herein relates to a portable office apparatus, hereafter referred to in one embodiment as an office-in-a-box. One embodiment of the portable office-in-a-box 100 comprises a substantially rectangular shaped box 400 comprising a base 202, a lid 204 configured to engage with the base 202 to define the rectangular shaped box 400, multiple panels 206, one or more enclosures 216, multiple mounting fixtures 210, and office equipment and office supplies. The portable office-in-a-box 100 allows a user to readily transport and set up an office and workstation at a transported location, for example, at a location remote from the user's brick and mortar office or residence, and to allow the user to work in an office setting at the transported location. FIG. 1 exemplarily illustrates a front left-side perspective view of the portable office-in-a-box 100 in an open configuration with one or more office items 102 disposed within the portable office-in-a-box 100. The portable office-in-a-box 100 addresses the need of a user for an office that is portable, transportable, and ready to function as a workstation and office at any location, for example, at a location remote from the user's brick and mortar office or residence. The portable office-in-a-box 100 is configured to accommodate office equipment within the box 100. As shown in FIGS. 1 and 2, the portable office-in-a-box 100 is configured to hold office items 102 comprising, but not limited to, a laptop 104, a 3 inches×3 inches standard post 106, a mobile phone 108, writing instruments 110, markers 112, one or more headphones 114, and miscellaneous office items 102 comprising a mouse 251, one or more chargers 252, a portable printer 117, a portable scanner 116, papers 239, a webcam 115, and power adaptors 253.

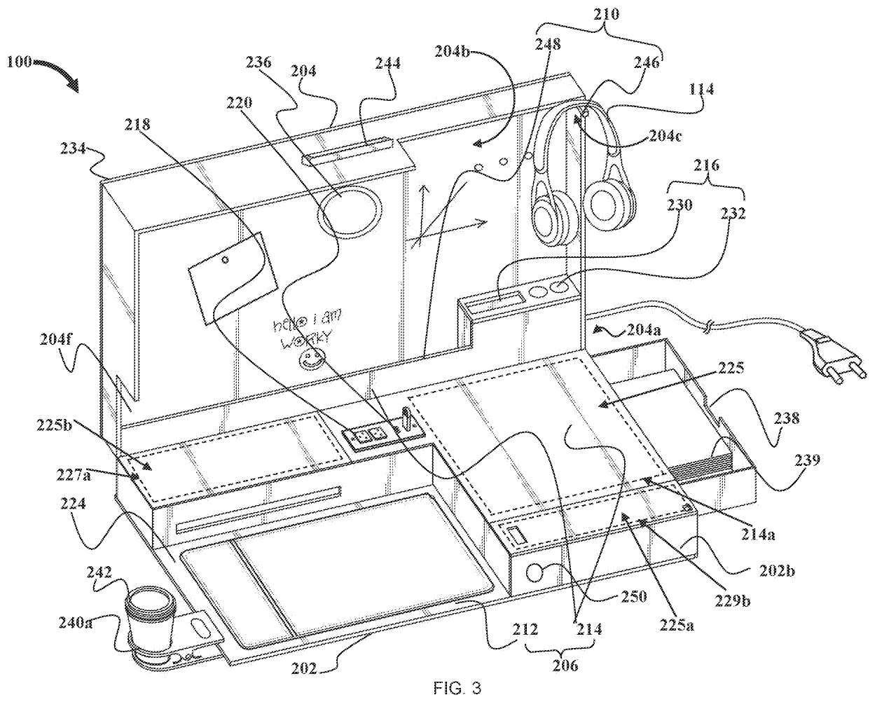

FIG. 2 exemplarily illustrates a front right-side perspective view of the portable office-in-a-box 100 in an open configuration. The portable office-in-a-box 100 is substantially rectangular in shape and comprises a base 202, a lid 204 configured to engage with the base 202, multiple panels 206, one or more storage compartments 208, 248, and 216 without a lid, and multiple mounting fixtures 210. In one embodiment, storage compartments 208, 248 and 216 are provided with a lid 227, 229 to enclose the contents within the storage compartments. The lid 204 of the portable office-in-a-box 100 when closed on the base 202 defines the substantially rectangular shaped portable office-in-a-box 100. The lid 204 when completely opened rests substantially perpendicular to the base 202. In an embodiment, the angle between the lid 204 and the base 202 can be varied to position the lid 204 at any angle between 60 degrees to 120 degrees. Multiple panels 206 are disposed within the inner surface 202a of the base 202 and the inner surface 204b of the lid 204. A first set 212 of the panels 206 is configured to secure one or more office items 102, and a second set 214 of the panels 206 defines one or more enclosures 216 in which office items 102 are positioned and secured. The storage compartments 208 are disposed on the base 202, and the mounting fixtures 210 are disposed on the inner surface 204b of the lid 204 for mounting office items 102. In an embodiment, the storage compartment 208 is a drawer 238, shown in FIG. 3, that slidably engages with the base 202 of the portable office-in-a-box 100. The portable office-in-a-box 100 is compact and has a desk surface dimension of, for example, about 26 inches in length, about 16 inches in width, and about 5 inches in height when closed. In one embodiment, the length, width, and thickness of the portable office-in-a-box is about 15.7 inches, 25.8 inches, and about 4.4 inches, respectively, although other dimensions are contemplated. One embodiment of the portable office-in-a-box 100 is manufactured from durable white wood or light wood with aluminium detailing. In an embodiment, the portable office-in-a-box 100 is manufactured from a thermoplastic, for example, Acrylonitrile Butadiene Styrene (ABS), Nylon, Polycarbonate, Kidex, etc. Kidex is a brand of thermoplastic acrylic-polyvinyl chloride material manufactured by Sekisui SPI of Bloomsburg, Pa., USA, etc.

As illustrated in FIG. 2, the portable office-in-a-box 100 further comprises a workspace 224 that is positioned leftward on the inner surface 202a of the base 202. The workspace 224 also functions as a storage area, configured to store, for example, a laptop 104. In an embodiment, the workspace 224 is configured to store a laptop having a length of about 12 to 18 inches, a width of about 8 to 12 inches, and a thickness of about 0.5 inch to 4 inches. In one embodiment, the workspace 224 is configured to store a MacBook Pro 13 inches laptop, manufactured by Apple Inc. of Cupertino, California, USA, having a screen size of 13.3 inches with a length of about 12 inches, width of 8.36 inches, and thickness of about 0.6 inch. The enclosures 216 comprise a first recess 226 disposed on the second set 214 of the panels 206, behind the workspace 224. The first recess 226 is configured to store the power adaptors associated with the laptop 104 and the mobile phone 108. In an embodiment, the first recess 226 is configured to be covered with a first lid 227. In an embodiment, the first recess 226 comprises a slot 226a configured to allow a charging cable to be drawn out of the first recess 226 and connected to the office items 102, for example, a laptop 104, mobile phone 108, etc. The enclosures 216 further comprises a second recess 228 disposed on the second set 214 of the panels 206 at a frontal right portion 202b of the base 202. The second recess 228 is configured to store writing instruments 110. In an embodiment, the second recess 228 is covered using the second lid 229. In an embodiment, the first lid 227 comprises a cut-out (not shown), similar to a cut-out 229a on the lid 229 of the second recess 228 to allow a plug of a power adaptor stored in the first recess 226 to be drawn through the cut-out 229a.

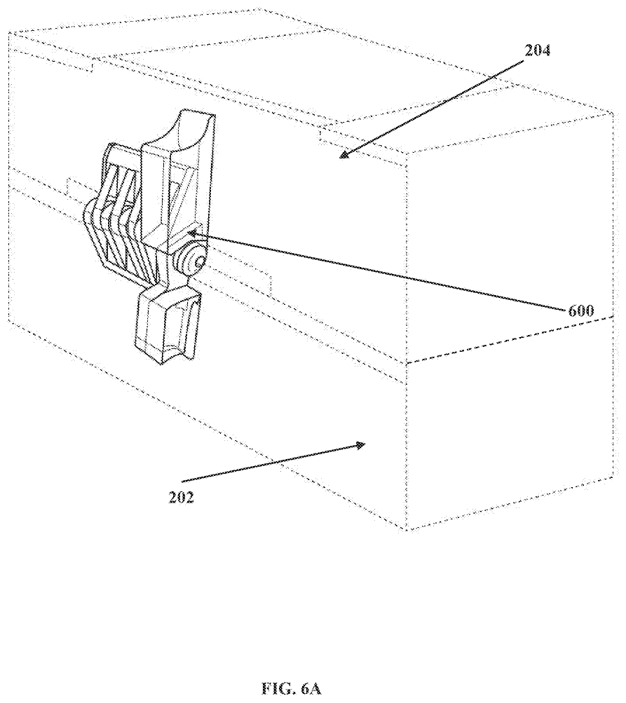

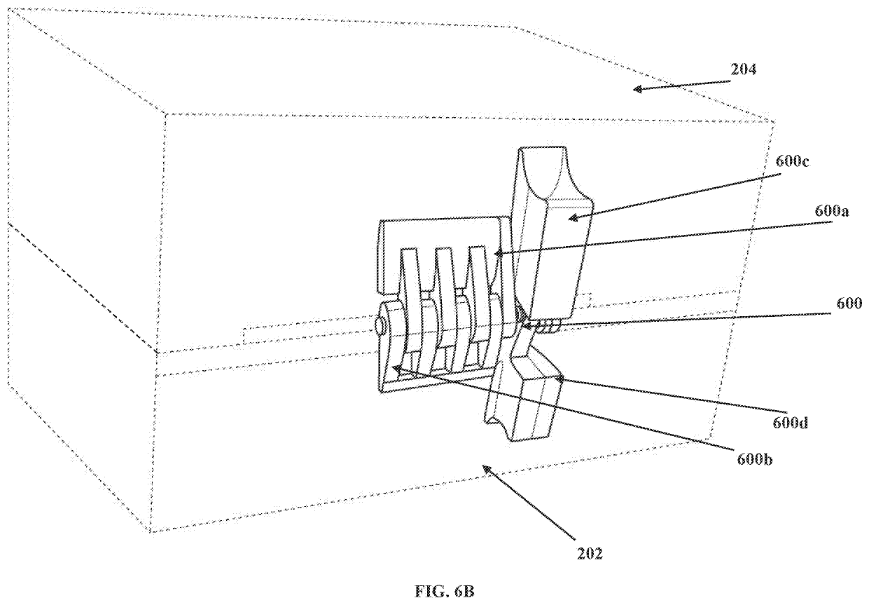

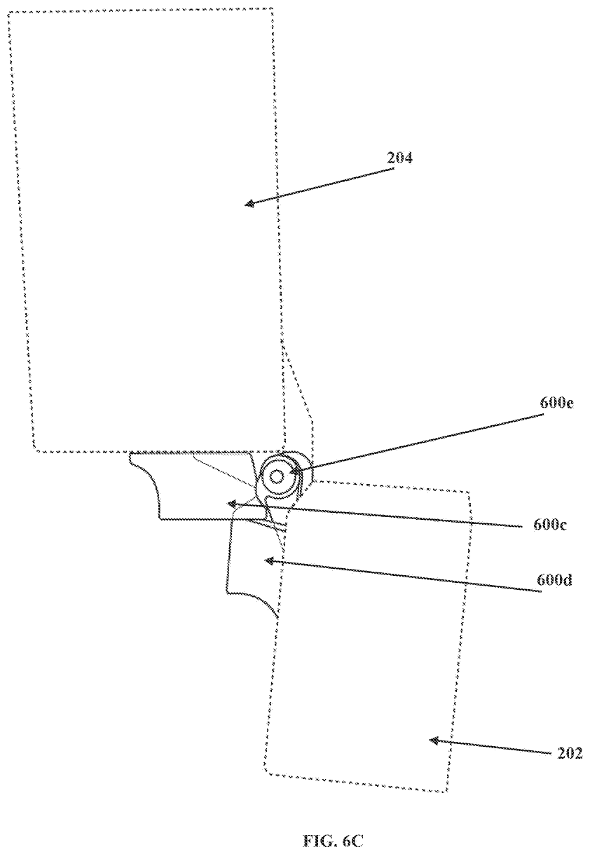

FIG. 3 exemplarily illustrates another front left-side perspective of the portable office-in-a-box 100 in the open configuration. In an embodiment, the portable office-in-a-box 100 comprises a set of power ports 218 and USB ports 220 disposed on the first set 212 of the panels 206 at about a mid-section of the base 202 and proximal to a hinge 600 between the base 202 and the lid 204, shown in FIGS. 6A-6C, to provide electrical power and media connectivity to electronic devices.

As shown in FIG. 3, in an embodiment, the enclosures 216 comprise a third recess 230 disposed at a bottom right section 204a of the lid 204, which is configured to store a 3 inches×3 inches standard post 106. The 3 inches×3 inches standard post 106 comprises a stack of adhesive papers with a re-adherable strip of glue on the back of each paper, where the paper is made to temporarily attach notes on surfaces. The third recess 230 is also configured to store a glue or other adhesive to secure the erasable panel 234 on an upper surface of the lid 204. The enclosures 216 further comprises one or more fourth recesses 232 disposed adjacent to the third recess 230 at the bottom right section 204a of the lid 204 to store markers 112 for the erasable panel 234. In an embodiment, the portable office-in-a-box 100 further comprises a magnetic erasable panel 234 disposed on an upper surface 204d of the lid 204. In another embodiment, the upper surface 204d of the lid 204 is used as an erasable panel. In an embodiment, the erasable panel is a magnetic panel configured to magnetically engage with a magnetic upper surface 204d of the lid 204. In an embodiment, the inner surface 204c of the lid 204 is used as an erasable panel. The portable office-in-a-box 100 further comprises a light source 236 disposed on the inner surface 204b of the lid 204 to provide illumination. In an embodiment, the light source 236 is position on an upper mid-section 204e of the inner surface 204b of the lid 204, as shown in FIG. 2. The light source 236 is, for example, a USB rechargeable ring light.

In an embodiment, the first set 212 of the panels 206 are configured to support placement or mounting of one or more office items 102 on their surfaces. In an embodiment, a top surface 214a of the second set 214 of the panels 206, shown in dotted lines in FIG. 3, that defines a top section of the storage compartment 208 is configured for use as a secondary workspace 225. In an embodiment, a top surface 227a of the first lid 227 of the first recess 226 and a top surface 229b of the second lid 229 of the second recess 228 are configured to be used as first and second extensions 225a and 225b of the secondary workspace 225.

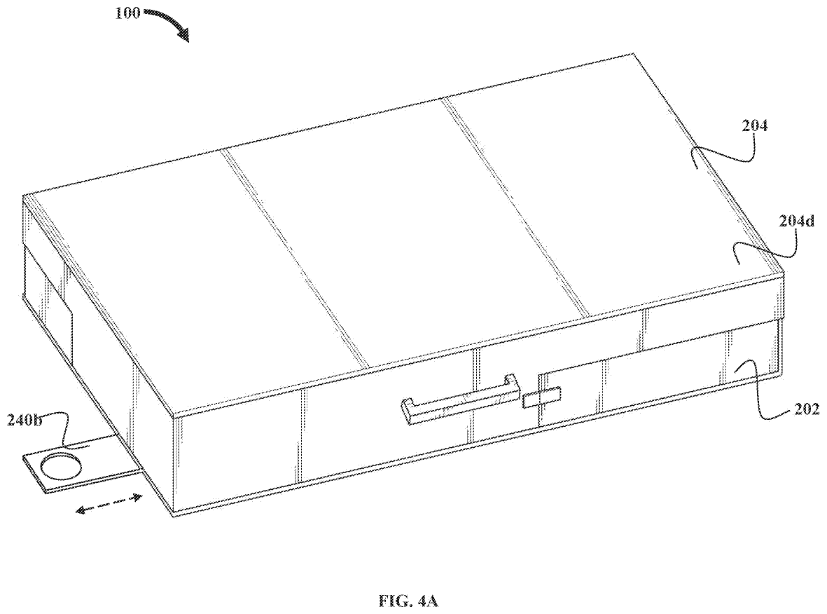

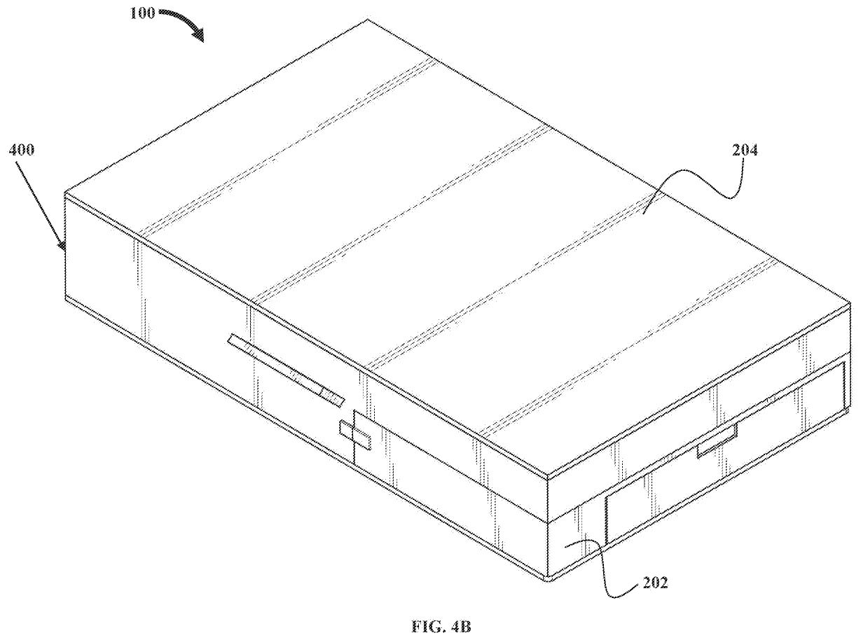

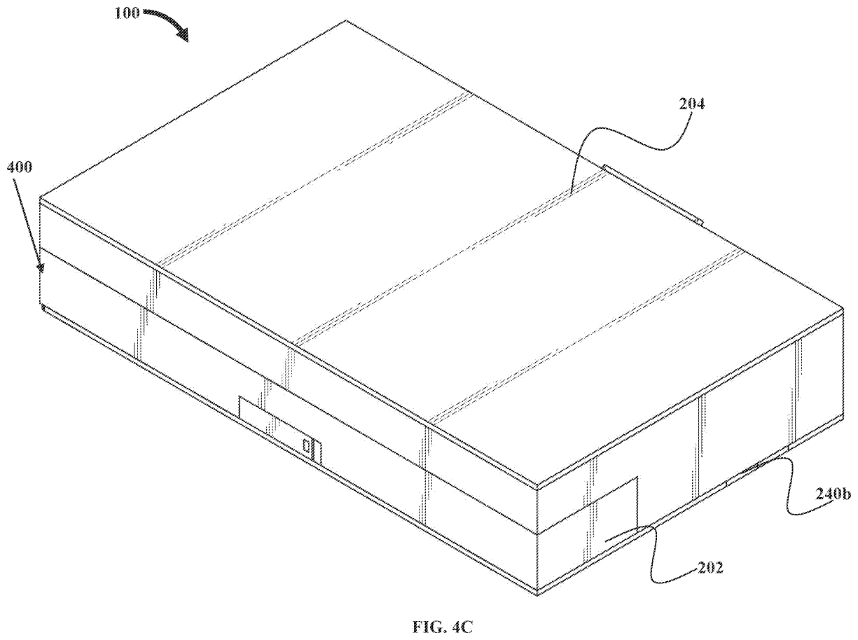

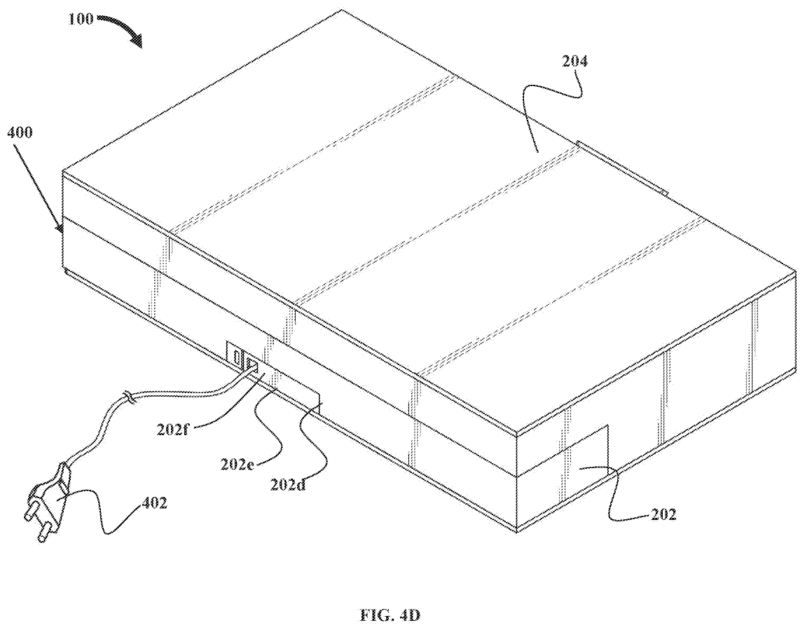

As shown in FIGS. 2 and 3, the storage compartments 208 comprise one or more drawers. In another embodiment, the storage compartments 208 comprise a filing cabinet storage compartment 238 recessed within the base 202. In an embodiment, the filing cabinet storage compartment 238 is a drawer configured to store papers 239. As an example, the filing cabinet storage compartment 238 is a foldable storage tray for storage of A4 size paper. In an embodiment, the portable office-in-a-box 100 further comprises one or more cup holders 240a and 240b. In an embodiment, as shown in FIGS. 1-3, the cup holder 240a is a clip-on cup holder 240a configured to be attached to the base 202, as shown in FIG. 3. As shown in FIG. 3, the cup holder 240a is attached to the base 202 to accommodate a mug or a disposable cup 242. In another embodiment, the cup holder 240b is a slide out cup holder, as shown in FIG. 4A. As shown in FIG. 4C, the slide out cup holder 240b is integrated and recessed within the base 202 when the portable office-in-a-box 100 is closed. The slide out cup holder 240b is extendable from the base 202, as shown by dotted arrow in FIG. 4A, and retracted into the base 202, as shown in FIG. 4C. The portable office-in-a-box 100 comprises a handle 244 to allow the portable office-in-a-box 100 when closed to be carried by a user like a briefcase.

In an embodiment, the mounting fixtures 210 comprises a spring loaded retractable pin 246 disposed at an inner edge 204c of the lid 204 for mounting one or more headphones 114, as shown in FIGS. 2 and 3. As illustrated in FIG. 2, when the lid 204 is closed over the base 202, the tip 246a of the spring loaded retractable pin 246, as shown in FIG. 1, is pressed against the lid 229 of the second recess 228 to allow the pin 246 to retract in to the lid 204. The spring-loaded retractable pin 246 is configured to be used as a hold-down for the lid 204. The spring-loaded retractable pin 246 further provides an interlock for the lid 204 when the lid 204 is closed over the base 202.

As shown in FIG. 3, the office-in-a box 100 comprises a phone holder channel 248 disposed adjacent to the third recess 230 and at a bottom section of the inner surface 204b of the lid 204. The phone holder channel 248 extends from the third recess 230 to a bottom left section 204f of said lid 204. The phone holder channel 248 is configured to mount and secure one or more mobile phones 108.

FIGS. 4A-4C exemplarily illustrates a front left-side top perspective view, another top perspective view, and a rear perspective view respectively of the portable office-in-a-box 100 in the closed configuration. FIG. 4D exemplarily illustrates a plug-in adapter 402 of the portable office-in-a-box 100 that extends from a rear portion 202d of the portable office-in-a-box 100. The plug-in adapter 402 is stored within a recess 202e at the rear portion 202d of the portable office-in-a-box 100. The recess 202e comprises a door 202f that slidably engages with the rear portion 202d to close the recess 202e when the plug-in adapter 402 is retracted into the recess 202e and to open the recess 202e when the plug-in adapter 402 is extended from the recess 202e.

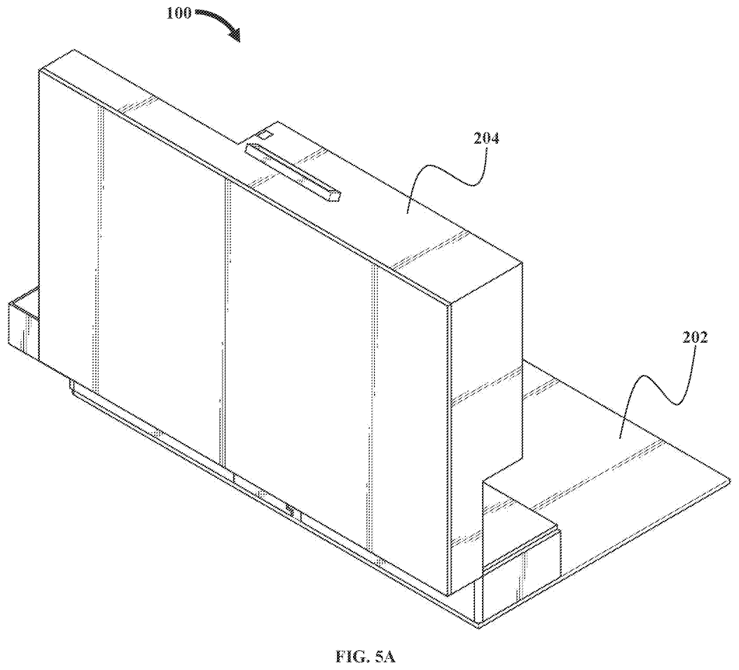

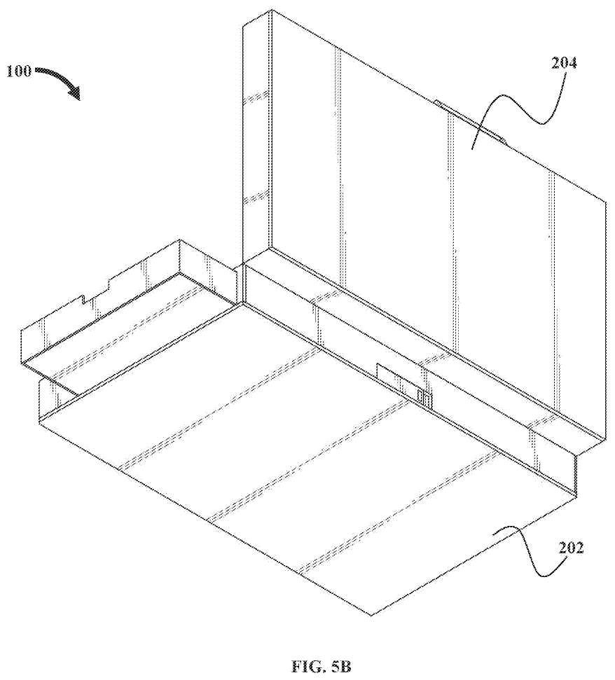

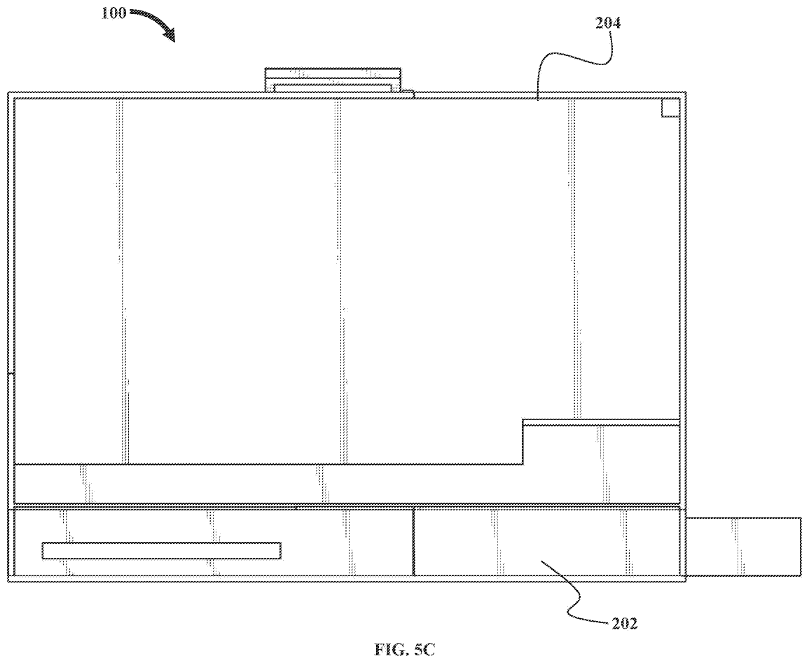

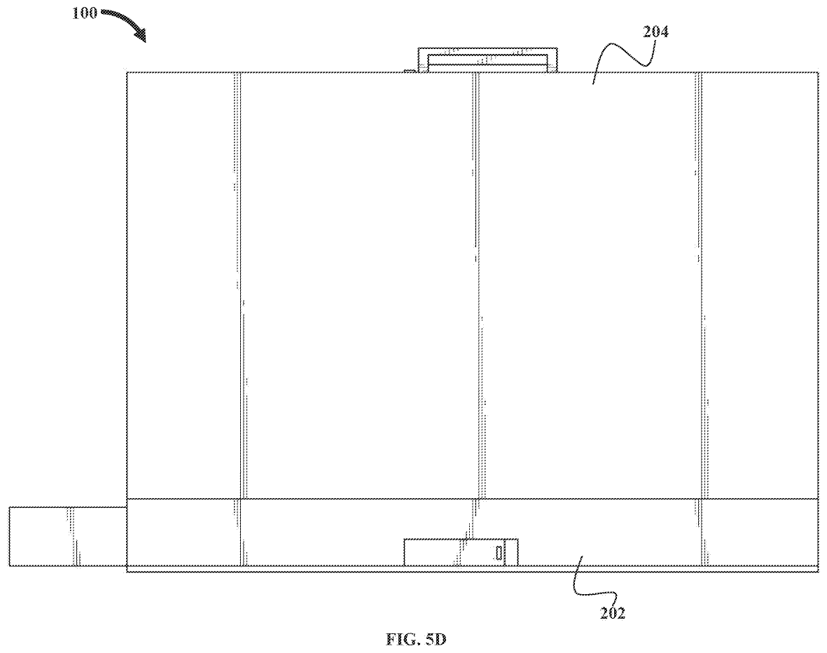

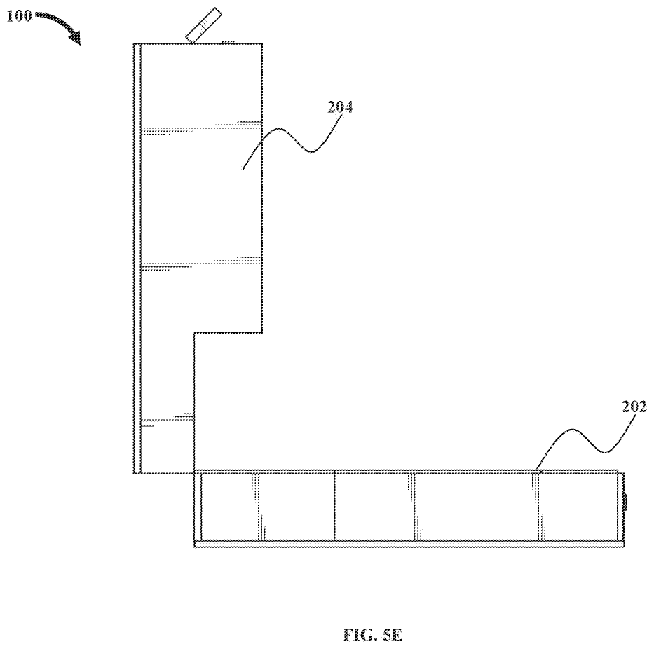

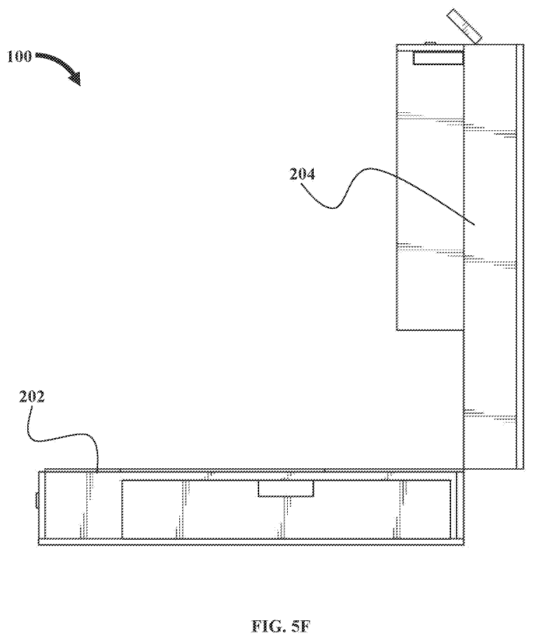

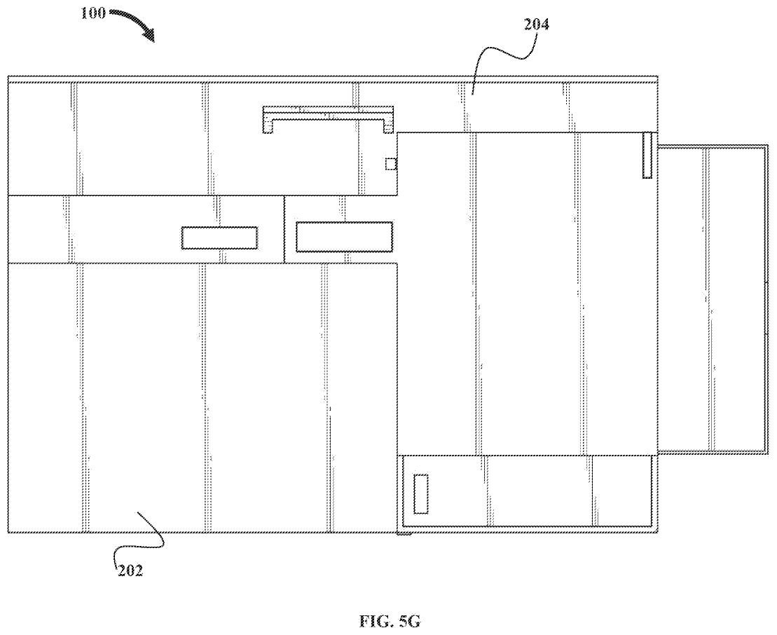

FIGS. 5A-5G exemplarily illustrates a rear perspective view, a bottom perspective view, a front orthogonal view, a rear orthogonal view, a left side orthogonal view, a right-side orthogonal view, and a top plan view respectively, of the portable office-in-a-box 100 in an open configuration.

In an embodiment, FIG. 6A-6C illustrates the portable office-in-a-box 100 with a hinge 600 disposed between the lid 204 and the base 202, for hingedly connecting the lid 204 to the base 204. In an embodiment, the hinge 600 is a piano type hinge comprising a first wing 600a attached to the lid 204 and a second wing 600b attached to the base 202, as shown in FIG. 6B. The first and second wings 600a and 600b rotatably engage with a pin 600e, disposed on either sides of the pin 600e, as shown in FIG. 6C. The hinge 600 is made of flexible nylon or a synthetic plastic. In an embodiment, the hinge 600 comprises a first stopper 600c attached to the first wing 600a, and a second stopper 600d attached to the second wing 600d, as shown in FIG. 6B. As shown in FIG. 6C, the first stopper 600c is configured to engage with the second stopper 600d when the lid is opened to prevent the lid 204 from tilting beyond a certain angle with respect to the base 202. In an embodiment, the hinge 600 is configured to position the lid 204 substantially perpendicular to the base 202 when the lid 204 is completely opened. In an embodiment, the hinge 600 is configured to position the lid 204 at any angle between 90 degrees to 120 degrees. In an embodiment, the hinge 600 comprises a lockable pin 600e configured to lock the lid 204 with the base 202, at any angle between 60 degrees to 120 degrees. In an embodiment, the portable office-in-a-box 100 further comprises a security latch 250 disposed at a frontal right portion 202b of the base 202. The security latch 250 is configured to provide a user secure access to the portable office-in-a-box 100.

The portable office-in-a-box 100 is compact and is shipped to customers in a lid-type cardboard box (not shown) that opens on the side where the handle 244 of the portable office-in-a-box 100 is present. Once the cardboard box is opened, a customer can easily remove the portable office-in-a-box 100 out of the cardboard box. In an embodiment, the cardboard box conforms to drop requirement ASTM D5276-19.

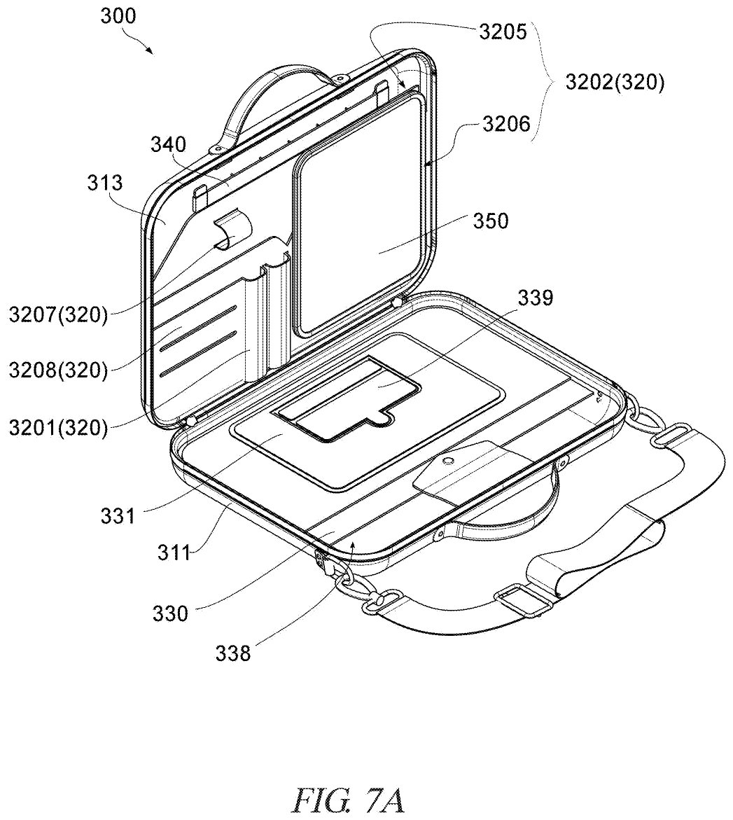

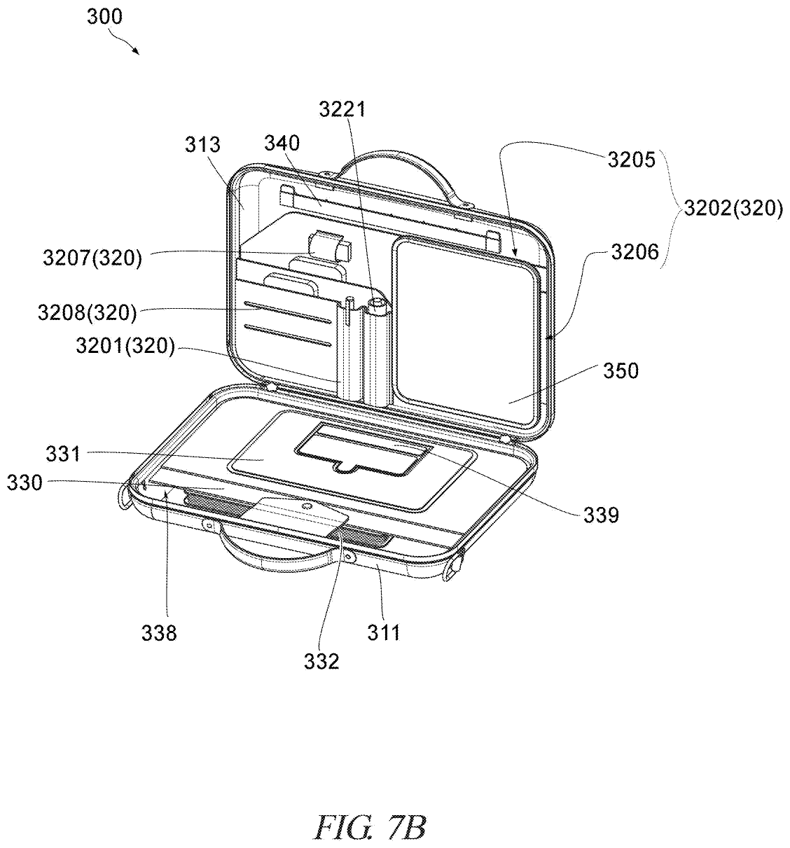

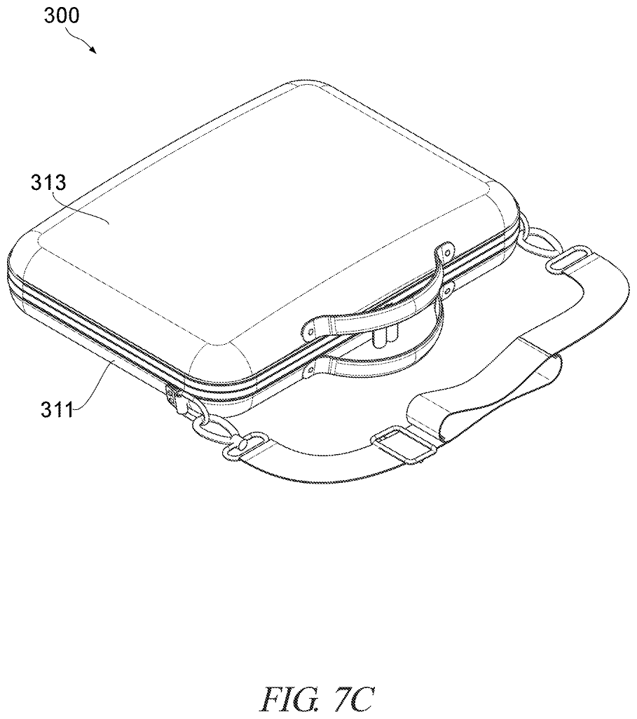

In the embodiment of FIGS. 1-6C, there is a described a portable office solution that comprises various features and components within a box-shaped environment. While the embodiment of FIGS. 1-6C shows certain features and components, it will be appreciated that alternative embodiments of portable office solutions including certain features and components are contemplated. FIGS. 7A-7C show one alternative embodiment of a portable office, it being understood that other constructions including different features or combinations of features are contemplated. As one example, in the embodiment of FIGS. 7A-7C, a portable office 300 is provided with various features and components, but not, for example, a plug-in adapter (e.g., a plug-in adapter 402 shown in FIG. 4D). In addition, as explained below, the portable office 300 may include a rechargeable light source.

FIG. 7A exemplarily illustrates a front perspective view of one embodiment of a portable office 300 in an open configuration. FIG. 7B exemplarily illustrates another front perspective view of the portable office 300 in an open configuration and in use. FIG. 7C exemplarily illustrates a front perspective view of the portable office 300 in a closed configuration. As shown in FIGS. 7A-7B, the portable office 300 may include a base 311 and a lid 313, the lid 313 configured to engage with the base 311, it being understood that the terms base and lid are spatially relational and not meant to be limiting. As shown in FIG. 7C, the lid 313 and base 311 may be secured relative to each other to form a closed condition. The portable office 300 may include one or more holders 320 including, but not limited to, a portable computer holder 330, a detachable illumination or light source 340, and a detachable and erasable board 350. The one or more holders 320 may be configured to hold one or more office items and accessories. The office items and accessories are either stored or mounted within the portable office 300. Examples of the office items and accessories may include, but are not limited to, a marker, a paper, a writing instrument, a mobile phone stand, a notebook, and a business card.

The portable computer holder 330 may be configured to function as a stand for a portable computer when the portable computer is in use, and to hold or store the portable computer when the portable computer is not in use. In the illustrated example, the portable computer holder 330 may be configured as a part of a pocket 338 that is configured to store the portable computer therein. In some embodiments, the portable computer holder 330 may include a heat dissipation surface 331 that is configured to dissipate heat when the portable computer is placed thereon. In some embodiments, the portable computer holder 330 may include a folding portable computer stand 339 configured to stand the portable computer in an upright condition, such as if the portable computer is a mobile device such as a mobile phone or a mobile device in the shape of a pad or screen.

In some embodiments, the detachable illumination or light source 340 may be detachable from the portable office 300. The detachable light source 340 may include a Universal Serial Bus (USB) rechargeable light that enables charging through a USB port in a computer or a USB power source attached to a wall outlet or the like. In some embodiments, the detachable light source 340 may be a light bar or linear in shape, but the shape of the light source 340 may be any other shape. The light source 340 may be disposed at the lid 313, and as illustrated in FIGS. 7A-7B, the light source 340 may be disposed at an upper part of the lid 313, although other locations are possible.

The detachable and erasable board 350 may be detachable from the portable office 300. The detachable and erasable board 350 may be configured to perform as a writing surface and a dry erase board. In some embodiments, the detachable and erasable board 350 may be disposed between the detachable light source 340 and the base 311, although other locations are possible. The detachable and erasable board 350 may be detachably attached to the lid 313 in such a manner that it may pivot around a longitudinal edge of the board 350 to reveal one or more pockets 3205 as described below.

In some embodiments, as shown in FIGS. 7A-7B, the one or more holders 320 may further include a built-in markers holder 3201, one or more pockets 3202, a horizontal elastic holder 3207, and an accessory organizer 3208. The markers holder 3201 may be configured to store markers 3221. The pockets 3202 may be disposed at the lid 313. The one or more pockets 3202 may include a pocket 3205. The pocket 3205 may be configured to store papers (not shown). In the illustrated example, the pocket 3205 is disposed between the detachable and erasable board 350 and the lid 313 and may be revealed by pivoting the detachable and erasable board 350 relative to and away from the lid 313. The one or more pockets 3202 may include an additional pocket 3026 between the detachable and erasable board 350 and the lid 313. The additional pocket 3026 may be configured to store one of the office items and accessories. In some embodiments, the horizontal elastic holder 3207 may be disposed at the lid 313. The horizontal elastic holder 3207 may be configured to hold a writing instrument (e.g., pencils, pens, and/or markers) horizontally, or to hold a cable (e.g., small power cords). The accessory organizer 3208 may be configured to hold, at the lid 313, at least one of: a writing instruments (e.g., pencils, pens, and/or markers); a mobile phone stand; a notebook; and business cards.

In some embodiments, one or more configurations of the portable office-in-a-box 100 explained with reference to FIGS. 1-6C may be incorporated into the portable office 300 explained with reference to FIGS. 7A-7C. In addition, in some embodiments, one or more components of the portable office 300 may be omitted in the portable office 300.

The foregoing examples have been provided merely for illustration and are in no way to be construed as limiting of the portable office-in-a-box 100 and the portable office 300 disclosed herein. While the portable office-in-a-box 100 and the portable office 300 have been described with reference to various embodiments, it is understood that the words, which have been used herein, are words of description and illustration, rather than words of limitation. Further, although the portable office-in-a-box 100 and the portable office 300 have been described herein with reference to particular means, materials, and embodiments, the portable office-in-a-box 100 and the portable office 300 are not intended to be limited to the particulars disclosed herein; rather, the functionality extends to all functionally equivalent structures and uses, such as are within the scope of the appended claims. Those skilled in the art, having the benefit of the teachings of this specification, may effect numerous modifications thereto and changes may be made without departing from the scope and spirit of the portable office-in-a-box 100 and the portable office 300 disclosed herein in their aspects.

We claim:

1. A portable office, comprising:
a base and a lid, the lid configured to engage with the base;
one or more holders configured to hold one or more office items and accessories, wherein the office items and accessories are either stored or mounted within the portable office;
a portable computer holder configured to stand a portable computer when the portable computer is in use, and to hold the portable computer when the portable computer is not in use;
a detachable light source, wherein the light source is a Universal Serial Bus (USB) rechargeable light; and
a detachable and erasable board, wherein the detachable and erasable board is configured to perform as a writing surface and a dry erase board, wherein the one or more holders include:
a built-in markers holder configured to store markers;
one or more pockets at the lid, the one or more pockets including a pocket that is configured to store papers; and
an accessory organizer that is configured to hold, at the lid, at least one of:
a writing instrument; a mobile phone stand; a notebook; and a business card.

2. The portable office of claim 1, wherein the detachable and erasable board is disposed between the detachable light source and the base.

3. The portable office of claim 1, wherein the portable computer holder includes a heat dissipation surface that is configured to place the portable computer.

4. The portable office of claim 3, wherein the portable computer holder is configured as a part of a pocket that is configured to store the portable computer.

5. The portable office of claim 3, wherein the portable computer holder includes a folding portable computer stand.

6. The portable office of claim 1, wherein the one or more holders includes a horizontal elastic holder at the lid, the horizontal elastic holder being configured to hold a writing instrument horizontally, or to hold a cable.

7. The portable office of claim 1, wherein the pocket that is configured to store papers is disposed between the detachable and erasable board and the lid.

8. The portable office of claim 1, wherein the one or more pockets include an additional pocket between the detachable and erasable board and the lid, the additional pocket being configured to store one of the office items and accessories.

9. The portable office of claim 1, wherein the detachable and erasable board is disposed between the detachable light source and the base,
wherein the portable computer holder includes a heat dissipation surface that is configured to place the portable computer,
wherein the portable computer holder is configured as a part of a pocket that is configured to store the portable computer,
wherein the portable computer holder includes a folding portable computer stand,
wherein the one or more holders includes a horizontal elastic holder at the lid, the horizontal elastic holder being configured to hold a writing instrument horizontally, or to hold a cable,
wherein the pocket that is configured to store papers is disposed between the detachable and erasable board and the lid, and
wherein the one or more pockets include an additional pocket between the detachable and erasable board and the lid, the additional pocket being configured to store one of the office items and accessories.

10. A portable office, comprising:
a base and a lid, the lid configured to engage with the base; and
one or more holders configured to hold one or more office items and accessories, wherein the office items and accessories are either stored or mounted within the portable office.
